(19) United States
(12) Patent Application Publication
(10) Pub. No.: US 2024/0160844 A1
(43) Pub. Date: May 16, 2024

(54) SYNONYM SEARCHING SYSTEM AND METHOD

(71) Applicants: Inventec (Pudong) Technology Corporation, Shanghai (CN); INVENTEC CORPORATION, TAIPEI CITY (TW)

(72) Inventors: Wei-Chao CHEN, TAIPEI CITY (TW); Chen-I HUANG, TAIPEI CITY (TW); Yu-Lun CHANG, TAIPEI CITY (TW); Chuo-Jui WU, TAIPEI CITY (TW); Chih-Pin WEI, TAIPEI CITY (TW)

(21) Appl. No.: 18/165,947

(22) Filed: Feb. 8, 2023

(30) Foreign Application Priority Data
Nov. 11, 2022 (CN) 202211410888.7

(51) Int. Cl. G06F 40/247

(52) U.S. Cl. CPC G06F 40/247

(57) ABSTRACT

The present disclosure provides a synonym searching method, which includes steps as follows. When receiving the vocabulary and the definition of the vocabulary from the user device, the natural language processing model is used to search the synonym of the vocabulary from the data governance dictionary according to the definition of the vocabulary; after providing the synonym to the user device, feedback information about the synonym is received from the user device, and the feedback information is used as the token of the vocabulary for the natural language processing model.

### CROSS-REFERENCE TO RELATED APPLICATION

This application claims priority to China Application Serial Number 202211410888.7, filed Nov. 11, 2022, which is herein incorporated by reference.

### BACKGROUND

### Field of Invention

The present invention relates to systems and methods, and more particularly, a synonym searching system and a synonym searching method.

### Description of Related Art

Currently, while the data governance defines the synonym, the user uses the Chinese and English vocabularies to inquire whether these vocabularies have synonyms and changes the Chinese and English vocabularies to be the same as the Chinese and English synonyms. When the vocabularies are not changed, the synonyms are needed to be defined specifically, so that the vocabularies can be synonymous with the synonyms. At the same time, in the process of data governance, the user also needs to judge the type of the vocabulary according to the active or passive status of the synonym. This method may cause the following disadvantages: 1. Manual query is time-consuming and labor-intensive; 2. Human errors (e.g., typing errors) may cause the synonym not to be found; 3. The original Chinese and English vocabularies are different, but they are forced to be changed to the same vocabulary because they are synonyms; 4. The user may miss synonyms by using the Chinese and English vocabularies for search because he or she doesn't know that these vocabularies actually have the synonyms; 5. Setting the type of the vocabulary by the user is easy to make mistakes, resulting in repeated types or omissions.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides synonym searching systems and methods, to solve or circumvent aforesaid problems and disadvantages in the related art.

An embodiment of the present disclosure is related to a synonym searching system, and the synonym searching system includes a transmission device, a storage device and a processor. The storage device is configured to store a data governance dictionary and a natural language processing model. The processor is electrically connected to the storage device and the transmission device. The processor is configured to use the natural language processing model to search a synonym of a vocabulary from the data governance dictionary according to a definition of the vocabulary when receiving the vocabulary and the definition of the vocabulary from a user device, the transmission device is configured to receive feedback information about the synonym from the user device after the transmission device provides the synonym to the user device, and the processor is configured to use the feedback information as a token of the vocabulary for the natural language processing model.

In one embodiment of the present disclosure, the processor stores the vocabulary, the definition of the vocabulary, and a relevant data of the feedback information in the storage device to update the data governance dictionary.

In one embodiment of the present disclosure, the processor adjusts the natural language processing model based on a user uploaded data.

In one embodiment of the present disclosure, the processor modifies an output layer in the natural language processing model based on the user uploaded data, and fine-tunes parameters of multiple layers before the output layer.

In one embodiment of the present disclosure, the natural language processing model comprises at least one of a pre-trained bidirectional language model, a pre-trained unidirectional language model and a pre-trained neural network model.

Another embodiment of the present disclosure is related to a synonym searching method, and the synonym searching method includes steps of: using a natural language processing model to search a synonym of a vocabulary from a data governance dictionary according to a definition of the vocabulary when receiving the vocabulary and the definition of the vocabulary from the user device; receiving feedback information about the synonym from the user device after providing the synonym to the user device, and updating the data governance dictionary based on the vocabulary, the definition of the vocabulary, and a relevant data of the feedback information.

In one embodiment of the present disclosure, the synonym searching method further includes steps of: using the feedback information as a token of the vocabulary for the natural language processing model.

In one embodiment of the present disclosure, the synonym searching method further includes steps of: storing the vocabulary, the definition of the vocabulary and a relevant data of the synonym in the data governance dictionary when the feedback information agrees with the synonym.

In one embodiment of the present disclosure, the synonym searching method further includes steps of: modifying an output layer in the natural language processing model based on a user uploaded data, and fine-tuning parameters of multiple layers before the output layer.

In one embodiment of the present disclosure, the natural language processing model comprises at least one of a pre-trained bidirectional language model, a pre-trained unidirectional language model and a pre-trained neural network model.

In view of the above, the synonym searching system and synonym searching method of the present disclosure can solve or circumvent aforesaid problems and disadvantages in the related art, thereby reducing the possibility of errors and improving the efficiency of time and manpower.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram of a synonym searching system according to some embodiments of the present disclosure;

FIG. 2 is a graph of a training accuracy according to some embodiments of the present disclosure;

FIG. 3 is a graph of a training loss according to some embodiments of the present disclosure; and

FIG. 4 is a flow chart of a synonym searching method according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

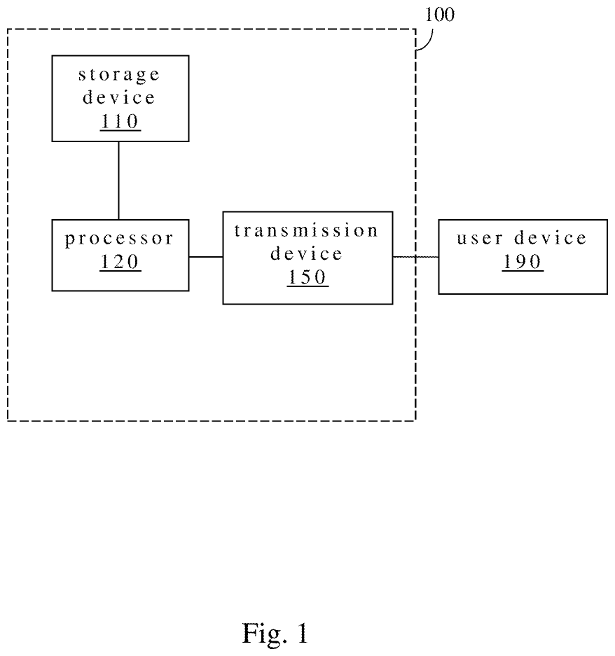

Referring to FIG. 1, in one aspect, the present disclosure is directed to a synonym searching system 100. This system may be applied in data governance and may be applicable or readily adaptable to all technologies. In some embodiments, the data governance refers to a set of practices, policies, and roles related to the collection, management and utilization of data, with the purpose of ensuring that data provides as much value as possible within the organization. Accordingly, the synonym searching system 100 has advantages. Herewith the synonym searching system 100 is described below with FIG. 1.

The subject disclosure provides the synonym searching system 100 in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

FIG. 1 is a block diagram of a synonym searching system according to some embodiments of the present disclosure. As shown in FIG. 1, the synonym searching system 100 includes a storage device 110, a processor 120 and a transmission device 150. For example, the storage device 110 can be a hard disk, a flash storage device or another storage media, the processor 120 can be a central processor, a controller or other circuits, and the transmission device 150 can be a transmission interface, transmission line, network device, communication device or other transmission medium.

In structure, the storage device 110 is electrically connected to the processor 120, and the processor 120 is electrically connected to the transmission device 150. The data transmission can be performed between the transmission device 150 and the user device 190. In practice, for example, the user device 190 can be a computer, a mobile phone, an input/output device or other electronic devices. It should be noted that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. For example, the storage device 110 may be a built-in storage device that is directly connected to the processor 120, or the storage device 110 may be an external storage device that is indirectly connected to the processor 120 through the wire connection.

In use, the storage device 110 stores a data governance dictionary and a natural language processing model. In practice, for example, the data governance dictionary is a dictionary that can be used to query metadata, data definition, data source and so on of above-mentioned data. The natural language processing refers to enabling computers to understand human language through software processes.

The processor 120 can use the synonym data in the data governance dictionary and/or external data to train the natural language processing model. In some embodiments, for example, a total of 991 vocabularies have been collected in the current data governance process, and 780 vocabularies have synonyms, in which the definitions of 556 vocabularies are the same as the definitions of their synonyms, and 224 vocabularies having not the same definitions only have minor differences of a few words; for example: “EBO project name” and “name of EBO project”, “supplier” and “supplier name”, “product category” and “product type”, and so on. In order to avoid the problem of insufficient existing data, open source data can be used to train the natural language processing model.

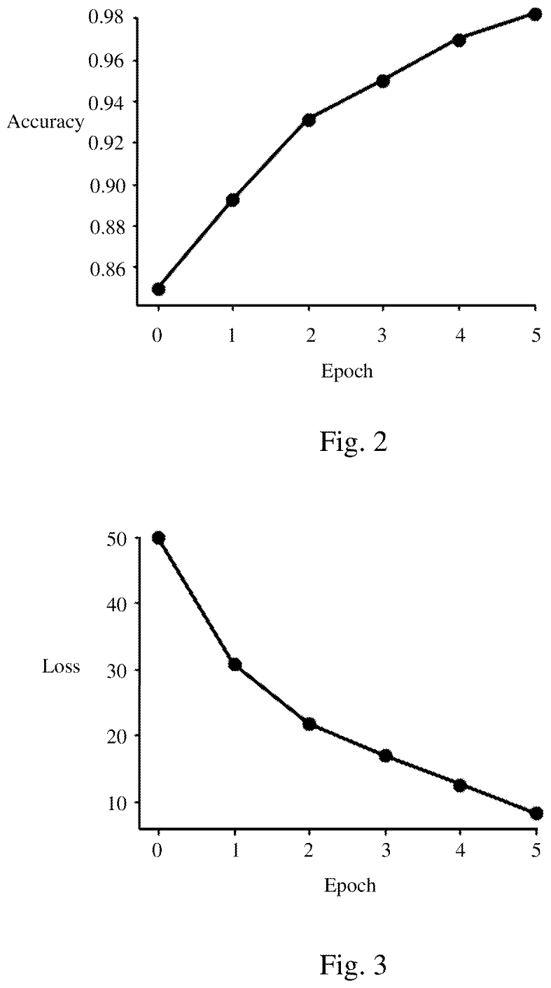

For example, use a WSDM-fake news classification data set and pre-trained natural language processing model, this data set is an open data set on the Kaggle network platform, and the content of the data set is false news classifications, in which each line of data contains two fake news headlines. When the two headlines describe the same fake news, they are marked as agreed. When the two headlines describe different fake news, they will be marked as disagreed. When the two headlines are completely irrelevant, they will be marked as unrelated. The 2% data of the data set have a total of 5314 items for the fine-tuning of the pre-trained natural language processing model, so as to achieve an accuracy of 98% (as shown in FIG. 2 and FIG. 3) under 6 training epochs. The fine-tuned natural language processing model is used to predict 224 vocabularies with different definitions in the data governance dictionary, so as to achieve an accuracy of about 75%. Furthermore, with the use of more data and parameter adjustments, and the continuous collection of digital transformation data, a more accurate natural language processing model can be trained.

After the natural language processing model is pre-trained, in some embodiments of the present invention, the natural language processing model refers to a pre-trained natural language processing model, which can be, for example, a pre-trained bidirectional language model, a pre-trained unidirectional language model, a pre-trained neural network model, a pre-trained other model, or any combination thereof.

Regarding the above-mentioned bidirectional language model, in some embodiments, for example, the bidirectional language model can include a BERT model, which is a natural language processing model proposed by Google in 2018. This model includes hundreds of millions of parameters and uses more than 3 billion single-character words have been trained, and the field of natural language processing is widely used, in which the open source version provides Chinese and English pre-trained models for use.

Regarding the above-mentioned unidirectional language model, in some embodiments, for example, the unidirectional language model can include a GPT model, which is proposed by OpenAI and currently has three types: GPT-1, GPT-2, and GPT-3 versions. The architecture of the GPT model is similar to the architecture of the BERT model, the difference is that the BERT model is a bidirectional language model, the GPT model is a unidirectional language model, and the parameters of the GPT model are more than the parameters of the BERT model.

Regarding the above-mentioned neural network model, in some embodiments, for example, the neural network model can include an elmo model that is earlier than the BERT model and the GPT model, and the architecture of the elmo model is a typical neural network.

After the pre-training of the natural language processing model is completed, the synonym searching system 100 allows users to query synonym. In use, the user can send the vocabulary and the definition of the vocabulary to the synonym searching system 100 through the user device 190 to query the synonym. When the transmission device 150 receives the vocabulary and the definition of the vocabulary from the user device 190, the processor 120 is configured to use the natural language processing model to search the synonym and the type suggestion of the vocabulary from the data governance dictionary according to the definition of the vocabulary. In this way, the natural language processing model can get more accurate results by searching through the definition of the vocabulary. In some embodiments, for example, the vocabulary input by the user may be a word, compound words or sentence in a single language or multiple languages (e.g., Chinese and English), and the type suggestion provided by the synonym searching system 100 can be word formation, word change and relationship between morphemes of the vocabulary and/or the synonym, but the present disclosure is not limited thereto.

After the transmission device 150 provides the synonym to the user device 190, the transmission device 150 is configured to receive feedback information about the synonym from the user device 190 and the processor 120 is configured to use the feedback information as a token of the vocabulary for the natural language processing model. For example, the feedback information input by the user can agree or disagree with the synonym suggested by the synonym searching system 100. When the token of the vocabulary received by the natural language processing model agrees with the synonym suggested by the synonym searching system 100, the natural language processing model still provide the same or similar synonym while receiving the same vocabulary for search; otherwise, when the token of the vocabulary received by the natural language processing model does not agree with the synonym suggested by the synonym searching system 100, and when the total number of disagreed tokens reaches the preset number (e.g., once or more than once), the natural language processing model can optionally not provide the same synonym while receiving the same vocabulary for search, but the present disclosure is not limited thereto.

In some embodiments of the present disclosure, the processor 120 stores the vocabulary, the definition of the vocabulary, and a relevant data of the feedback information in the storage device 110 to update the data governance dictionary. For example, when the feedback information input by the user can agree with the synonym suggested by the synonym searching system 100, the processor 120 stores the vocabulary, the definition of the vocabulary and a relevant data of the synonym in the storage device 110 to update the data governance dictionary; otherwise, when the user inputs the feedback information can disagree with the synonym suggested by the synonym searching system 100, the processor 120 stores the vocabulary, the definition of the vocabulary and an incorrect suggestion related to the synonym in the storage device 110 to update to the data governance dictionary, but the present disclosure is not limited thereto.

In some embodiments of the present disclosure, the processor 120 adjusts the natural language processing model based on a user uploaded data. For example, the user uploaded data can be the data regularly uploaded by the user through the user device 190, or the user uploaded data can be the data of new vocabularies, definitions and synonyms in the data governance dictionary regularly compiled by the processor 120, but the present disclosure is not limited thereto.

Regarding the above-mentioned adjustment operation, in some embodiments of the present disclosure, the processor 120 modifies an output layer (e.g., the structure or parameters of the output layer) in the natural language processing model based on the user uploaded data, so as to meet actual needs, and the processor 120 fine-tunes parameters of multiple layers (e.g., several network layers close to the output layer, but not limited to) before the last layer (e.g., the output layer), so as to reduce the training time and improve performance, and the knowledge acquired by the natural language processing model is transferred to solve the actual problem of synonyms.

In view of above, the synonym searching system 100 uses the natural language processing model to read the definition of the vocabulary through the natural language processing technology, automatically classifies the correlation between the new vocabulary and all vocabularies of the vocabulary library of the data governance dictionary, provides possible synonyms, automatically set the vocabulary type, continuously collects data and user feedback, and regularly fine-tunes the model to make the model more accurate. Through the synonym searching system 100, the users does not need to use the Chinese and English vocabularies to search for possible synonyms and does not need to manually set the vocabulary type, the Chinese and English vocabularies do not need to be changed to be the same as the Chinese and English synonyms. This method solves the shortcomings of the previous technology and provides users with a simpler and faster searching method. If the company that uses the synonym search system 100 continues to promote data governance, the vocabulary library will become larger and larger, and the automated processing of the synonym searching system 100 will reduce the possibility of errors and improve the efficiency of time and manpower.

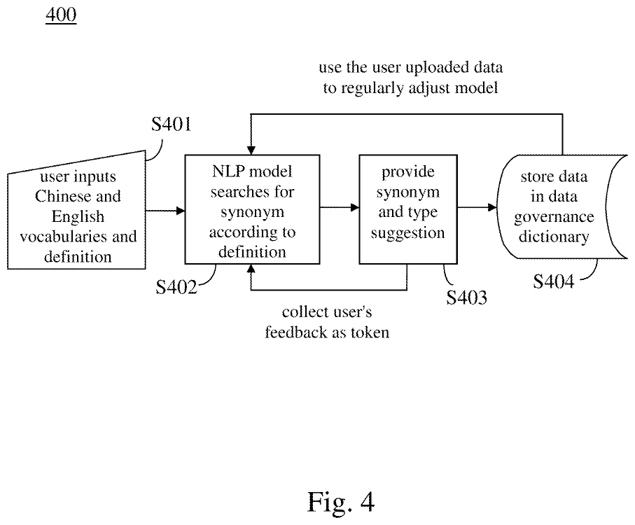

For a more complete understanding of a synonym searching method performed by the vocabularies system 100, referring FIGS. 1-4, FIG. 4 is a flow chart of a synonym searching method 400 according to an embodiment of the present disclosure. As shown in FIG. 4, the synonym searching method 400 includes operations S401 to S404. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

The synonym searching method 400 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

In operation S401, the user can input the vocabulary (e.g., the Chinese and English vocabularies) and the definition of the vocabulary through the user device 190. When receiving the vocabulary and the definition of the vocabulary from the user device 190, in operation S402, the natural language processing model (NLP model) searches for the synonym of the vocabulary from the data governance dictionary according to the definition of the vocabulary. In operation S403, the synonym and the type suggestion are provided.

In practice, for example, the usage process of the synonym searching method 400 includes steps as follows. Firstly, the user inputs the vocabulary and the definition of the vocabulary to be added to the data governance dictionary, the natural language processing model reads the definition of each vocabulary and performs a prediction based on the definition of the vocabulary and each definition of each vocabulary in the data governance dictionary, outputs the predicted vocabulary to the user device, allows the user to decide whether the predicted vocabulary is a real synonym, collects the user's decision as a token to feed back the model for fine-tuning. The experiment described in the above example predicts the 224 vocabularies with different definitions, the user inputs “Multiple Source Rate by Project by BU”, the vocabulary definition of “PCA Multiple source Rate achieved Status” in this table is “Based on Customer Goal divides the latest PCA Multiple Source Rate into two attainment statuses”. The natural language processing model searches the data governance dictionary based on this vocabulary definition and finds the vocabulary definition of “PCA Multiple source Rate achieved Status” of “Part SCM Property” and “according to the Reporting Customer Goal, the latest PCA Multiple Source Rate is divided into two qualification status” as a synonym that is output to user device 190, thereby allowing the user to decide whether agreeing or disagreeing with the synonym.

After the synonym is provided to the user device in operation S402, the user sends feedback information through the user device 190 to decide whether agreeing or disagreeing with the synonym. In operation S403, the feedback information about the synonym is received from the user device, and the feedback information is used as the token of the vocabulary for the natural language processing model. For example, when the token of the vocabulary received by the natural language processing model agrees with the synonym suggested by the synonym searching method 400, the natural language processing model still provide the same or similar synonym while receiving the same vocabulary for search; otherwise, when the token of the vocabulary received by the natural language processing model does not agree with the synonym suggested by the synonym searching method 400, and when the total number of disagreed tokens reaches the preset number (e.g., once or more than once), the natural language processing model can optionally not provide the same synonym while receiving the same vocabulary for search, but the present disclosure is not limited thereto.

In operation S404, the data governance dictionary is updated according to the vocabulary, the definition of the vocabulary and a relevant data of the feedback information. For example, when the feedback information input by the user can agree with the synonym suggested by the synonym searching method 400, in operation S404, the vocabulary, the definition of the vocabulary and a relevant data of the synonym are stored in the data governance dictionary; otherwise, when the user inputs the feedback information can disagree with the synonym suggested by the synonym searching method 400, in operation S404, the vocabulary, the definition of the vocabulary and an incorrect suggestion related to the synonym are stored in the data governance dictionary, but the present disclosure is not limited thereto.

In some embodiments of the present disclosure, in operation S404, the natural language processing model is adjusted based on the user uploaded data. For example, the user uploaded data can be the data regularly uploaded by the user through the user device 190, or the user uploaded data can be the data of new vocabularies, definitions and synonyms in the data governance dictionary regularly compiled by the processor 120, but the present disclosure is not limited thereto.

Regarding the above-mentioned adjustment operation, in some embodiments of the present disclosure, an output layer (e.g., the structure or parameters of the output layer) in the natural language processing model is modified based on the user uploaded data, so as to meet actual needs, and parameters of multiple layers (e.g., several network layers close to the output layer, but not limited to) before the last layer (e.g., the output layer) are fine-tuned, so as to reduce the training time and improve performance, and the knowledge acquired by the natural language processing model is transferred to solve the actual problem of synonyms.

In some embodiments of the present disclosure, in operation S402, the natural language processing model includes at least one of a pre-trained bidirectional language model, a pre-trained unidirectional language model and a pre-trained neural network model. Since the natural language processing model has a huge structure and a huge data set, a pre-trained natural language processing model is used to save time and to improve efficiency.

In view of the above, the synonym searching system 100 and synonym searching method 400 of the present disclosure can solve or circumvent aforesaid problems and disadvantages in the related art, thereby reducing the possibility of errors and improving the efficiency of time and manpower.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A synonym searching system, comprising:
a transmission device;
a storage device configured to store a data governance dictionary and a natural language processing model; and
a processor electrically connected to the storage device and the transmission device, the processor configured to use the natural language processing model to search a synonym of a vocabulary from the data governance dictionary according to a definition of the vocabulary when receiving the vocabulary and the definition of the vocabulary from a user device, the transmission device configured to receive feedback information about the synonym from the user device after the transmission device provides the synonym to the user device, and the processor configured to use the feedback information as a token of the vocabulary for the natural language processing model.

2. The synonym searching system of claim 1, wherein the processor stores the vocabulary, the definition of the vocabulary, and a relevant data of the feedback information in the storage device to update the data governance dictionary.

3. The synonym searching system of claim 1, wherein the processor adjusts the natural language processing model based on a user uploaded data.

4. The synonym searching system of claim 3, wherein the processor modifies an output layer in the natural language processing model based on the user uploaded data, and fine-tunes parameters of multiple layers before the output layer.

5. The synonym searching system of claim 1, wherein the natural language processing model comprises at least one of a pre-trained bidirectional language model, a pre-trained unidirectional language model and a pre-trained neural network model.

6. A synonym searching method, comprising steps of:
using a natural language processing model to search a synonym of a vocabulary from a data governance dictionary according to a definition of the vocabulary when receiving the vocabulary and the definition of the vocabulary from a user device; and
receiving feedback information about the synonym from the user device after providing the synonym to the user device, and updating the data governance dictionary based on the vocabulary, the definition of the vocabulary, and a relevant data of the feedback information.

7. The synonym searching method of claim 6, further comprising:
using the feedback information as a token of the vocabulary for the natural language processing model.

8. The synonym searching method of claim 6, further comprising:
storing the vocabulary, the definition of the vocabulary and a relevant data of the synonym in the data governance dictionary when the feedback information agrees with the synonym.

9. The synonym searching method of claim 6, further comprising:
modifying an output layer in the natural language processing model based on a user uploaded data, and fine-tuning parameters of multiple layers before the output layer.

10. The synonym searching method of claim 6, wherein the natural language processing model comprises at least one of a pre-trained bidirectional language model, a pre-trained unidirectional language model and a pre-trained neural network model.
